(19) United States
(12) Patent Application Publication
(10) Pub. No.: US 2017/0067818 A1
(43) Pub. Date: Mar. 9, 2017

(54) DETECTION SYSTEM FOR MONITORING A COMPONENT

(71) Applicant: CATERPILLAR INC., Peoria, IL (US)

(72) Inventor: Zachary S. Birky, Washington, IL (US)

(73) Assignee: CATERPILLAR INC., Peoria, IL (US)

(21) Appl. No.: 14/847,598

(22) Filed: Sep. 8, 2015

(51) Int. Cl. G01N 17/00; G01N 27/04

(52) U.S. Cl. CPC G01N 17/006; G01N 27/041

(57) ABSTRACT

A detection system for monitoring a component is disclosed. The component may be exposed to a condition that produces a change to the component. The detection system may have a sensor including a material sample configured to be exposed to the condition to produce a change to the material sample. The sensor may be configured to generate a signal indicative of the change to the material sample, which may be a step change in electrical resistance. The detection system may further have a controller configured to measure the change in electrical resistance based on the signal and determine the change to the component based on the measurement.

### TECHNICAL FIELD

The present disclosure relates generally to a detection system and, more particularly, to a detection system for monitoring a component.

### BACKGROUND

Over the course of a machine component lifetime, there may be many instances in which the component is exposed to conditions that change the component in some way, whether it be during a manufacturing process or during use in the field. For example, many machine components are manufactured using thermal processes such as nitriding, carburizing, boronizing, heat treatments, etc. to provide the component with a desired characteristic (e.g., strength, durability, rigidity, etc.) through a change to the chemical and/or physical structure of the component. In another example, there may be extreme operating conditions (e.g., high temperatures, pressures, environments, etc.) that similarly cause a change to the component while the component is in use in the field.

For many of the processes that are used for component manufacturing, it is difficult to monitor changes while the process is ongoing. For example, during a nitriding process, it is difficult to determine a timing of when nitriding begins and an amount of nitriding that has occurred at a given time during the process, because the chemical reactions that are occurring cannot be easily observed while the process is ongoing. Similar problems are faced in relation to components that are already in the field, as these components, especially engine components, may be exposed to component-altering extreme conditions that are unknown to an operator. These conditions may cause the component to fail if not identified in a timely manner.

One attempt to monitor changes to a machine component is disclosed in U.S. Pat. No. 4,595,427, which issued to Drew et al. on Jun. 16, 1986 (“the '427 patent”). The '427 patent discloses a method and arrangement for following and controlling heat treatment of a cold worked metal by monitoring a relative change in electrical resistivity of the metal during the heat treatment process. Samples of the metal before and after annealing are placed in a secondary furnace that is controlled to duplicate the temperature of a corresponding annealing furnace. A differential resistivity between the two samples is measured to provide feedback to control the annealing process.

While the system of the '427 patent provides a potential option for monitoring a heat treatment process, it is less than ideal. In particular, application of the system disclosed in the '427 patent may be limited to heat treatment processes, such as annealing, that predictably change an electrical resistivity of an entire component throughout the process. Processes such as nitriding (which affects a chemical structure of only an outer portion of a component) may not be compatible with the differential resistivity model used in the '427 patent . Further, the process and system of the '427 patent relies on a secondary furnace and multiple same-size samples to provide monitored results. This adds considerable expense and complexity to the process of the '427 patent.

The present disclosure is directed at overcoming one or more of the shortcomings set forth above and/or other problems of the prior art.

### SUMMARY OF THE DISCLOSURE

In one aspect, the present disclosure is directed to a detection system for monitoring a component. The component may be exposed to a condition that produces a change to the component. The detection system may include a sensor including a material sample configured to be exposed to the condition to produce a change to the material sample. The sensor may be configured to generate a signal indicative of the change to the material sample, which may be a step change in electrical resistance. The detection system may further include a controller configured to measure the change in electrical resistance based on the signal and determine the change to the component based on the measurement.

In another aspect, the present disclosure is directed to a detection system for monitoring a change to a component. The detection system may include a sensor. The sensor may include a material sample. The material sample may be configured to experience a change in a property only when the material sample is exposed to a temperature that is approximately above a threshold temperature. The detection system may further include a controller. The controller may be configured to measure the change in the property, and provide an indication of a remaining lifetime of the component based on the measured change.

In yet another aspect, the present disclosure is directed to a detection system for monitoring a component. The detection system may include a sensor. The sensor may include a first material sample configured to change after exposure to the process for a first period of time, the change being a change in electrical resistance. The sensor may also include a second material sample configured to change after exposure to the process for a second period of time, the change being a change in electrical resistance. The sensor may be configured to generate a first signal indicative of the change to the first material sample and a second signal indicative of the change to the second material sample. The detection system may also include a controller. The controller may be configured to measure the changes in electrical resistance based on the first and second signals, and determine a first change to the component and a second change to the component based on the measurements.

### BRIEF DESCRIPTION OF THE DRAWINGS

FIG. 1 is schematic illustration of an exemplary monitoring system that may be used to monitor a manufacturing process, consistent with disclosed embodiments;

FIG. 2 is a schematic illustration sensor that may be used in conjunction with the monitoring system of FIG. 1;

FIGS. 3A-3C are illustrations of a material sample that may be used in conjunction with the monitoring system of FIGS. 1 and 2, at various stages of a thermal process;

FIG. 4 is a graph depicting change in electrical resistance over time of the material sample of FIGS. 3A-3C;

FIG. 5 is a schematic illustration of another sensor that may be used in conjunction with monitoring system of FIG. 1; and

FIG. 6 is a schematic illustration of yet another sensor that may be used in conjunction with the monitoring system of FIG. 1

### DETAILED DESCRIPTION

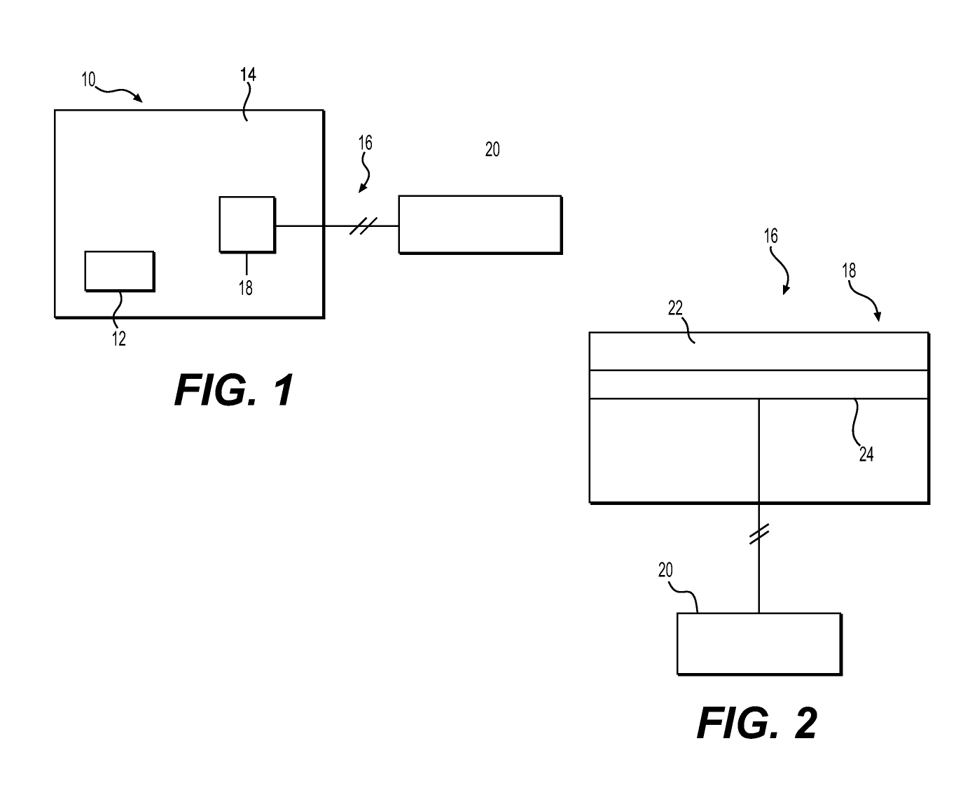

FIG. 1 illustrates a processing system 10 for exposing a component 12 to selected conditions. Processing system 10 may include a furnace 14 configured to expose component 12 to the selected conditions. It should be understood that furnace 14 is exemplary, and that other controlled-environment devices may be used (e.g., boiler, kiln, oven, cooler, forge, etc.). On a general level, the conditions inside of furnace 14 may include various temperatures and pressures, as well as exposure to one or more materials (including liquids and gasses). More specifically, the conditions inside of furnace 14 may be characterized by a process used to change component 12 in some way. Examples of such processes include thermal processes and/or heat treatment processes, such as nitriding, carburizing, boronizing, annealing, forging, normalizing, etc.

Nitriding is a process by which a case hardness of a component is increased by gradually diffusing nitrogen into the physical structure of the component, thereby creating a hardened surface layer. Gas nitriding, for example, may include exposing a component to a mixture including at least ammonia gas at relatively low temperatures (e.g., 900-1000° F.) for a selected period of time (e.g., 0.5-4 hours). Nitrogen atoms break down from the ammonia and diffuse from the exterior surface of the component, creating a hardened material at the surface of the component that includes a compound layer (also called the “white layer”) and a diffusion layer. The compound layer provides the component with improved wear and corrosion resistance and increased hardness while the diffusion layer provides additional strength and durability. Other diffusion processes, such as salt bath nitriding, ion (plasma) nitriding, carburizing, and boronizing, operate under similar principles. Heat treatment processes similarly change a chemical and physical structure of a component in order to produce a change to the component, such as a change in chemical, physical, or crystalline structure in order to alter a strength, hardness, durability, ductility, etc. of the component.

Component 12 may be any part or piece of material configured to be placed in furnace 14. In an exemplary embodiment, component 12 may be a metallic machine component, such as a gear, shaft, cam, valve, injector, cylinder, cylinder head, die, mold, fastener, tool, etc. Such components may be manufactured from steel or a steel alloy, but other materials are possible. Component 12 may be exposed to selected conditions in furnace 14 based on a manufacturing process selected for component 12. For example, component 12 may go through a nitriding cycle as part of a component finishing process prior to being placed in the field. It should be understood, however, that component 12 may be used in conjunction with processing system 10 for other purposes, including other manufacturing processes, remanufacturing processes, restoring processes, repairing processes, etc.

As described above, component 12 may be exposed to conditions inside of furnace 14 that produce a change to component 12. As used herein, a “change” to a component is a change to a chemical or physical property of the component. For example, creation of a surface layer of material (such as a compound layer produced by nitriding) and diffusion of the surface layer to a selected depth are changes to a component. Similarly, other changes in chemical composition, such as alloying of the material of component 12, are changes to a component. In other instances, a change in strength, durability, hardness, electrical resistance, etc., may constitute a change to a component. The changes may be intended or unintended results of the underlying process.

Returning to FIG. 1, a detection system 16 may be used to monitor the conditions inside of furnace 14 to provide feedback regarding the changes that are being experienced by component 12 as they occur. For example, detection system 16 may include one or more components that also experience a change as a result of being exposed to the conditions inside of furnace 14. The change to the one or more components of detection system 16 may be measured and used to determine the changes to component 12.

In an exemplary embodiment, detection system 16 may include a sensor 18 and a controller 20. Sensor 18 may be placed inside of furnace 14 such that sensor 18 is exposed to the conditions therein. For example, sensor 18 may be exposed to the temperatures, pressures, and materials that are used in the selected process to produce a change to component 12. In one example, sensor 18 may be exposed to features of a nitriding process (e.g., elevated temperatures and ammonia gas). The conditions inside of furnace 14 may cause a change to sensor 18.

Controller 20 may be a computing device configured to communicate with sensor 18. Controller 20 may embody a single microprocessor or multiple microprocessors that include a mechanism for receiving and interpreting signals from sensor 18. Numerous commercially available microprocessors can be configured to perform the functions of controller 20. It should be appreciated that controller 20 could readily be, at least in part, an electronic control module associated with furnace 14. Controller 20 may include a memory, a secondary storage device, a processor, and/or any other components for running an application. Various other circuits may be associated with controller 20 such as power supply circuitry, signal conditioning circuitry, solenoid driver circuitry, and other types of circuitry. Controller 20 may be separate from sensor 18 or may be built into an integral unit with sensor 18. In some embodiments, sensor 18 may include an additional processing device configured to communicate with controller 20, via a wired or wireless connection.

FIG. 2 further illustrates detection system 16, including sensor 18. In an exemplary embodiment, sensor 18 may include a sensor unit 22 and at least one material sample 24. Sensor unit 22 may be any mounting, housing, or containing device configured to help maintain material sample 24 in a selected position. Sensor unit 22 may further include electronic components, such as a processing device, circuitry, electrical contacts, etc.

Material sample 24 may be a ribbon, wire, or other piece of a selected material. Exposure to the conditions inside furnace 14 may cause a change to material sample 24. As used herein, a “change” to a material sample may include any change that may be identified by controller 20. In an exemplary embodiment, a change to a material sample may include a change in a physical property that may be measureable by controller 20. Other changes, such as chemical changes, may also be considered changes to a material sample.

In one example, a change to material sample 24 may include a change in electrical resistance. Monitoring a change in electrical resistance of material sample 24 may allow controller 20 to determine changes to component 12 based on a known relationship between a change in resistance and other changes. For example, a change in resistance of material sample 24 may be correlated with changes to component 12 that occur during a nitriding process. These changes to component 12 may include, for example, creation of a surface layer , diffusion of the surface layer to a selected depth, and diffusion rate of the surface layer.

In some embodiments, changes to component 12 may correlate with step changes in a property of material sample 24. A “step change” in a property (e.g., electrical resistance), as used herein, may be a substantially instantaneous change to the property where the change (e.g., increased or decrease) is by at least an order of three. In other words, a step change may be identified by a discontinuity in a property as measured over time.

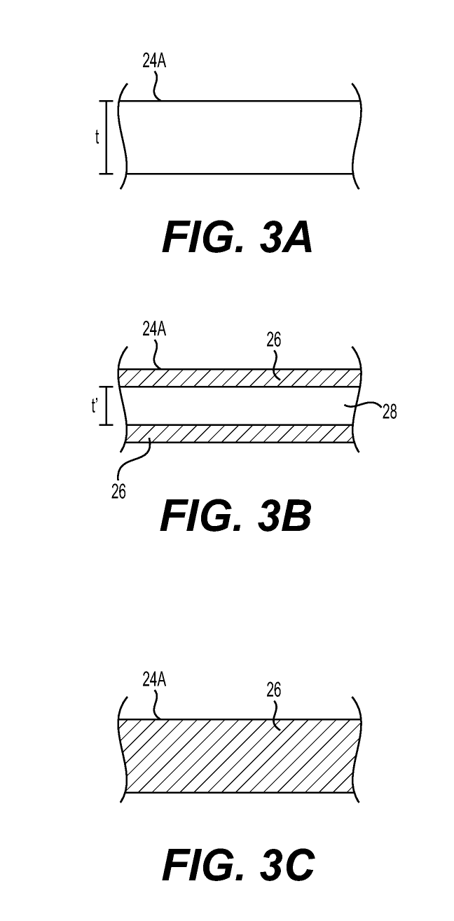

FIGS. 3A-3C depict a material sample 24A at various stages of a nitriding process. Material sample 24A may be exposed to the nitriding process, which may cause a change in a property of material sample 24A. For example, material sample 24A may experience a change in electrical resistance due to the nitriding process. The change may be, for example, a step change in electrical resistance. The step change in electrical resistance may be correlated with a change to a corresponding component (e.g., a component that is exposed to the same nitriding process) such that the change to the corresponding component may be determined.

In an exemplary embodiment, material sample 24A may be a ribbon or wire of material that includes a thickness t. The thickness t may be relatively thin. For example, the thickness t may be on the order of microns (e.g. 0.1-20 μm). Material sample 24A may include a selected material, such as a material selected for a rate at which a surface layer is created and/or diffuses from the surface during a nitriding process.

FIG. 3A depicts material sample 24A prior to any changes occurring due to a nitriding process. Material sample 24A in this instance does not yet include a surface layer, and thus, the thickness t is uniformly defined by the material that is used to form material sample 24A. In this state, material sample 24A may include a relatively low resistance. For example, material sample 24A may include a base electrical resistance associated with material sample 24A before any changes have occurred.

FIG. 3B depicts material sample 24A after formation of a surface layer 26. In an exemplary embodiment, surface layer 26 may be a compound layer formed due to the nitriding process. For example, material sample 24A may be placed in furnace 14 during a nitriding of component 12. During the nitriding process, surface layer 26 may be formed on material sample 24A (e.g., as a surface layer is formed on component 12). As shown in FIG. 3B, a surface layer 26 may be formed on both exterior surfaces of material sample 24A. The opposing surface layers 26 may diffuse toward each other as the nitriding process continues. In the depicted instance, a core layer 28 having a thickness t′ may remain. Core layer 28 may correspond to an area that surface layers 26 have yet to reach. While material sample 24A includes a core layer 28, an electrical resistance may remain relatively close to the base electrical resistance. That is, while surface layer 26 may be relatively non-conductive, the core layer 28 may allow for electrical conductivity. Thus, changes to electrical resistance may be linear as surface layers 26 grow.

FIG. 3C depicts material sample 24A after surface layers 26 meet. At this point, an entirety of the thickness t of material sample 24A is saturated by the surface layer 26 and there is no core layer 28 (e.g., t′=0). As surface layer 26 is a compound layer due to the nitriding process, material sample 24A may thus be formed from a hardened nitrogen-containing material, and thus be non-conductive. That is, a step change in electrical resistance may occur, as there is no longer a portion of material sample 24A that is configured to conduct electricity in the same manner as the original material of material sample 24A.

In some embodiments, material sample 24A may be configured to be regenerated for reuse. For example, after diffusion causes material sample 24A to be saturated by the surface layer 26 (i.e., the state of FIG. 3C), the material sample 24A could be exposed to or used in a process that allows material sample 24A to be reused in another process to detect a change. In one example, material sample 24A may be used in a process to remove material layer 26 (e.g., diffuse nitrogen out of material sample 24A).

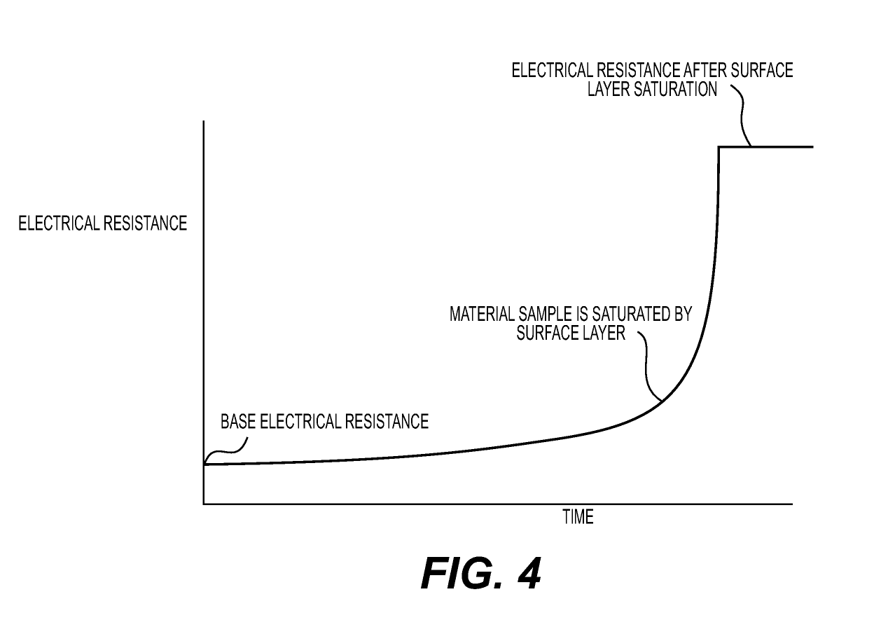

FIG. 4 is a graph generally depicting electrical resistance over time for material sample 24A exposed to a nitriding process, consistent with disclosed embodiments. Initially, material sample 24A includes a base electrical resistance, which is the electrical resistance of material sample 24A prior to surface layers 26 being formed. As the nitriding process continues, the electrical resistance begins to increase, caused by the formation and growth of surface layers 26. While the change in electrical resistance during this stage is depicted as constant, it should be understood that the change may be accelerated to some degree as core layer 28 decreases to zero. When the two surface layers 26 meet and material sample 24A is saturated, a step change in electrical resistance is seen. For example, electrical resistance may increase by an order of ten. As shown in the graph, the step change is a large instantaneous change in the electrical resistance, resulting in the discontinuity shown.

Controller 20 may be configured to monitor material sample 24A while the nitriding process occurs. For example, controller 20 may be configured to measure the electrical resistance of material sample 24A. Based on the measured electrical resistance, controller 20 may be configured to determine a change to component 12. For example, a step change in electrical resistance to material sample 24A may be correlated with a change to component 12, based on a known thickness t of material sample 24A and a known material of component 12 and material sample 24A. Identification of the step change by controller 20 may indicate a change to component 12.

For example, if component 12 and material sample 24A are known to be the same material, it can be expected that a surface layer will be formed and grow at approximately the same timing and rate for each. Therefore, if controller 20 determines that surface layers 26 have saturated material sample 24A (e.g., based on the occurrence of a step change in electrical resistance), controller 20 may determine that a surface layer equal to one half of the thickness t of material sample 24A may have been formed on component 12. The surface layer of component 12 may be half of the thickness t because surface layers 26 formed on two sides of material sample 24A. For example, if material sample 24A includes a thickness t=4 μm, controller 20 may determine that component 12 includes a surface layer of approximately 2 μm when a step change in electrical resistance to material sample 24A is detected. In this way, controller 20 may determine a change to component 12 (e.g., diffusion of a surface layer to a selected depth) based on a change to material sample 24A.

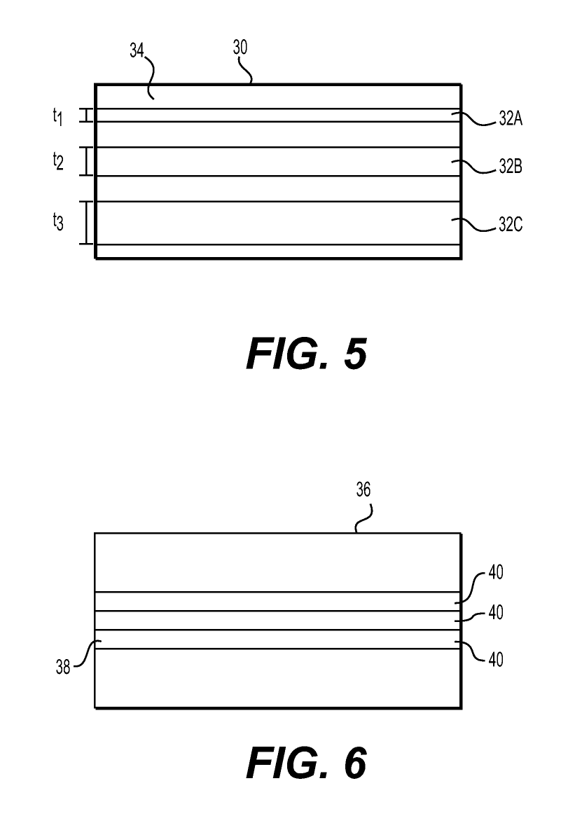

FIG. 5 illustrates another sensor 30, consistent with disclosed embodiments. Sensor 30 may be similar to sensor 18, except sensor 30 may include a plurality of material samples 32A, 32B, and 32C, instead of a single material sample 24. Sensor 30 may include a sensor unit 34 configured to house, mount, and/or contain material samples 32A-C and/or maintain material samples 32A-C in a selected position in furnace 14. In this way, controller 20 may monitor each material sample 32A-C and determine multiple different changes to component 12 based on the corresponding changes to material samples 32A-C.

In one example, each material sample 32A-C may include a different thickness t₁, t₂, and t₃, respectively. The thickness t₁, t₂, and t₃ may be selected thicknesses at which the nitriding process will cause the material sample to be saturated by a surface layer at a time corresponding to a particular change to component 12. For example, thickness t₁ of material sample 32A may be very thin (e.g., 0.1-0.5 μm), such that saturation occurs almost instantly after a surface layer is formed. In this way, a step change in electrical resistance of material sample 32A may correspond to a timing of formation of a surface layer on component 12. Thickness t₂ of material sample 32B may be larger than the thickness t₂ of material sample 32A. For example, thickness t₂ may be approximately equal to 2 μm. In this way, a step change in electrical resistance of material sample 32B may correspond to diffusion of a surface layer on component 12 to approximately 1 μm. Thickness t₃ of material sample 32C may be larger still, such that diffusion of the surface layer on component 12 to a larger depth may be determined. For example, thickness t₃ may be approximately equal to 4 μm, such that diffusion of the surface layer on component 12 to 2 μm may be determined. In an exemplary embodiment, a material sample 32A-C may be formed with a thickness that corresponds to diffusion of a surface layer on component to a selected depth within the range of 0.5-50 μm. It should be understood, however, that other thicknesses may be possible to detect diffusion to other (e.g., larger) selected depths.

Material samples 32A-C of sensor 30 may be connected to controller 20 such that controller 20 may measure an associated electrical resistance. In one embodiment, controller 20 may separately measure an electrical resistance of each material sample 32A-C. For example, controller 20 may measure three separate electrical resistance values and determine that a change has occurred based on a step change in one or more of the material samples 32A-C. In another embodiment, controller 20 may be connected to material samples 32A-C in series. For example, controller 20 may measure a total electrical resistance of material samples 32A-C and determine that a change has occurred based on a step change in the total electrical resistance. This information can be combined with known information (e.g., that the material samples 32A-C will saturate in order of thickness) to determine changes to component 12.

Using sensor 18 and/or sensor 30, controller 20 may be configured to monitor a nitriding process and determine when changes to component 12 occur. In some embodiments, sensors 18 and/or 30 may be used and/or adapted for use with other processes. Carburizing and boronizing, for example, are similar processes that create a surface layer. A material sample 24 may be created such that a step change in electrical resistance to the material sample 24 may signal a corresponding change to component 12 due to the process (e.g., formation of a surface layer or diffusion of the surface layer to a selected depth). Controller 20 may be further configured to monitor oxidation, for example, to determine an amount of corrosion that a component 12 has experienced. For example, a material sample 24 may be placed in the field to be exposed to the same conditions as a selected component. Electrical resistance of the material sample 24 may be periodically measured (e.g., by controller 20) to identify any step changes in electrical resistance. If such a change is identified, controller 20 may determine an approximate amount of corrosion that the component has experienced (e.g., a depth to which the oxidation has diffused from the surface of the component).

In some embodiments, a material of material sample 24 may be selected based on a manner in which it is known to change during a particular process. For example, the material of material sample 24 may be selected to be the same material as component 12. In this way, it can be expected that material sample 24 will be affected in approximately the same way as component 12 (e.g., formation of a surface layer at the same time, diffusion of the surface layer to a particular depth at the same time, etc.). However, it is not necessary that material sample 24 be the same material as component 12. For example, in some instances, material sample 24 may include a material that is different than a material of component 12, but that reacts to a process (e.g., nitriding) in the same or similar manner. In this way, material sample 24 may be formed from a material that is, for example, less expensive than a material of component 12 or reacts to a process in the same or similar manner as many other materials. In other instances, material sample 24 may be formed from a material that reacts to a process at a faster or slower rate than a material of component 12. The faster or slower rate may be correlated with the change to component 12, while allowing for a larger or smaller material sample 24 than would be necessary if the material were the same as the material of component 12.

FIG. 6 depicts another sensor 36, consistent with disclosed embodiments. In an exemplary embodiment, sensor 36 may include a material sample 38 that includes a plurality of layers 40 of a plurality of different materials. The combination of the layers 40 may allow material sample 38 to be used with other processes where, for example, conditions vary from cycle to cycle. For example, material sample 38 may include a combination of layers 40 that experiences a measurable change in a property at a set combination of times and temperatures.

In an exemplary embodiment, material sample 38 may experience a change in a property only when material sample 38 is exposed to a temperature that is approximately above a threshold temperature. The term “only” as used in conjunction with this embodiment indicates that the change does not occur as a result of temperature at temperatures below the threshold. A material sample that changes in the property under other conditions (e.g., addition of a material) may still “only” change when the material sample is exposed to a temperature above a threshold, as long as a temperature below the threshold alone is insufficient to produce the change. In one example, the different materials of layers 40 may alloy (e.g., mix) after exposure to a particular temperature for a particular period of time. The mixing (or another effect) may cause the measurable change in a property, such as a change in electrical resistance.

Controller 20 may be connected to material sample 38 and configured to measure the change in the property (i.e., the property that only changes when material sample 38 is above a threshold temperature). In addition, controller 20 may be configured to provide an indication of a remaining lifetime of a corresponding component 12 based on the measured change to material sample 38. For example, component 12 may be exposed to extreme field conditions which cause temperature spikes. After enough time at a particular temperature, component 12 may need to be replaced. Controller 20 may be configured to identify such components 12 based on a sensor 36 that includes a material sample 38 described above. The indication provided by controller 20 may include one or more of a binary indication (e.g., Part OK/Replace Part), an estimated lifetime remaining, a value of the measured property, or other indication that may be used by an operator to determine whether the component 12 should be replaced.

It should be understood that, in some embodiments, sensors 18, 30, and/or 36 may be adapted such that controller 20 may determine a change to component 12 based on a change to a material sample other than a step change in electrical resistance. For example, controller 20 may monitor a material sample for a change in other electrical changes (e.g., inductance, capacitance, etc.) or physical changes (e.g., Young's modulus, yield or tensile strength, resonant frequency, etc.). Moreover, controller 20 may be configured to identify changes other than diffusion of a surface layer or an amount of time spent at a temperature. For example, other changes to a component 12 that may be measured using a corresponding change to a material sample include, for example, surface layer diffusion rates, absorption data, reaction timings, part-specific properties, etc.

In some embodiments of sensor 30, material samples 32A-C may each include a different material configured to change in a different manner under the same conditions, such that different changes to a component 12 may be identified. For example, sensor 30 may include a multi-layer material sample for identifying an amount of time spent above a threshold temperature, an iron material sample for identifying surface layer formation, a selected alloy material sample for providing data specific to a part that reacts in the same manner as the alloy, a high-alloy material for identifying diffusion rates, and materials such as titanium, nickel, and copper for identifying absorption or reaction rates and occurrences under different conditions.

In another alternative embodiment, sensors 18, 30, and/or 36 may be adapted to measure an unknown condition. For example, an alternative embodiment of sensor 18 may include an aftertreatment sensor configured to be exposed to exhaust gasses that are released by an engine. The alternative sensor 18 may include a material sample configured to experience a change (e.g., a step change in electrical resistance) given certain conditions of the exhaust gas. For example, if the exhaust gas includes excess nitrogen, the ammonia may cause nitriding of a material sample of alternative sensor 18, which may eventually cause the step change in electrical resistance. Controller 20 may thereby determine that the exhaust gas exceeds allowable standards, for example.

### Industrial Applicability

The disclosed detection system may be used to determine changes to a component and/or an environmental condition based on changes to a material sample. The disclosed detection system may be particularly applicable to monitoring a thermal process, such as nitriding, that is otherwise difficult to monitor while the process is ongoing. For example, the disclosed detection system may determine a timing of formation of a surface layer and a timing of when the surface layer diffuses to a selected depth. In other embodiments, the disclosed detection system may be used to simultaneously monitor for different changes to a component, based on changes to different material samples.

Consistent with disclosed embodiments, one or more material samples may be placed in the same environment as a component, thereby exposing the material sample(s) to the same conditions as the component. The material sample(s) may be selected for the manner in which they react to certain conditions which provides insight into corresponding changes to the component. For example, a material sample that is saturated by a surface layer may indicate that a corresponding amount of surface layer diffusion has occurred to the component. In another example, an amount of alloying that has occurred may indicate that the component has been exposed to temperatures above a threshold for a corresponding amount of time. This information may be used as a process check, likelihood of part failure, indication of an environmental condition, to provide details about the properties of a component, and/or as a factor in another determination.

In an exemplary embodiment, detection system 16 may be implemented in a method to monitor component 12 that is exposed to a condition. The method may include exposing material sample 24 to the condition, thereby causing material sample 24 to change in electrical resistance. For example, a thin ribbon of a material may be placed in furnace 14 to monitor a nitriding process. As the process occurs, controller 20 may measure the change in electrical resistance of material sample 24. Eventually, controller 20 may identify a step change in electrical resistance of material sample 24. For example, when material sample 24 is saturated by a surface layer, the electrical resistance may increase by an order of ten, thereby producing a step change in electrical resistance. Controller 20 may measure the step change and determine a change to component 12 based on the measurement. For example, controller 20 may determine that a surface layer has diffused to a selected depth on component 12, based on a known thickness t of material sample 24 (e.g., the selected depth may be equal to one half of the thickness t).

The above process may allow for an efficient and cost-effective manner in which to monitor a nitriding process. Rather than stopping the process or using an expensive thermal sensor, a small material sample may be used to identify the changes. The resulting identification of formation of a surface layer and/or diffusion of the surface layer to a selected depth may be used as a process check to determine whether the nitriding cycle is occurring as desired and/or as an indication that the nitriding cycle should be stopped or adjusted in some manner. This allows an operator to finely control nitriding and other similar processes to efficiently produce components that have desired properties (e.g., surface layer with a selected depth).

As has been described, the disclosed concepts have broad application to other processes, such as heat treatment processes, as well as exposure to environmental conditions in the field. For example, depth of corrosion of a part may be identified based on corrosion of a material sample (e.g., and a corresponding step change in electrical resistance). In another example, a simple part check may be accomplished by using a material sample that changes resistance only when exposed to temperatures above a threshold. These and other applications are contemplated to provide sensors and detection systems that allow a component to be monitored based on changes to a selected material sample.

It will be apparent to those skilled in the art that various modifications and variations can be made to the detection system. Other embodiments will be apparent to those skilled in the art from consideration of the specification and practice of the disclosed detection system. It is intended that the specification and examples be considered as exemplary only, with a true scope being indicated by the following claims and their equivalents.

What is claimed is:

1. A detection system for monitoring a component that is exposed to a condition that produces a change to the component, the detection system comprising:
a sensor including a material sample configured to be exposed to the condition to produce a change to the material sample, wherein the sensor is configured to generate a signal indicative of the change to the material sample, and wherein the change to the material sample is a step change in electrical resistance; and
a controller configured to measure the change in electrical resistance based on the signal and determine the change to the component based on the measurement.

2. The detection system of claim 1, wherein the change to the component is creation of a surface layer.

3. The detection system of claim 1, wherein the change to the component is the diffusion of a surface layer to a selected depth.

4. The detection system of claim 3, wherein the material sample includes a thickness equal to twice the selected depth.

5. The detection system of claim 3, wherein the selected depth is in a range from 0.5-50 μm.

6. The detection system of claim 1, wherein
the sensor includes a plurality of material samples, and
the controller is configured to determine more than one change to the component based on detection of changes to more than one of the plurality of material samples.

7. The detection system of claim 6, wherein the more than one change to the component includes creation of a surface layer and diffusion of the surface layer to a selected depth.

8. The detection system of claim 6, wherein the more than one change to the component includes diffusion of a surface layer to a first selected depth and diffusion of the surface layer to a second selected depth.

9. The detection system of claim 1, wherein the material sample and the component are formed from the same material.

10. The detection system of claim 1, wherein the material sample and the component are formed from different materials.

11. A detection system for monitoring a change to a component, the detection system comprising:
a sensor including:
a material sample, wherein the material sample is configured to experience a change in a property only when the material sample is exposed to a temperature that is approximately above a threshold temperature; and
a controller configured to:
measure the change in the property, and
provide an indication of a remaining lifetime of the component based on the measured change.

12. The detection system of claim 11, wherein the material sample includes a plurality of layers, each layer being a different material.

13. A detection system for monitoring a component, the detection system comprising:
a sensor including:
a first material sample configured to change after exposure to the process for a first period of time; and
a second material sample configured to change after exposure to the process for a second period of time,
wherein the sensor is configured to generate a first signal indicative of the change to the first material sample and a second signal indicative of the change to the second material sample; and
a controller configured to:
measure the changes to the first and second material samples based on the first and second signals, and
determine a first change to the component and a second change to the component based on the measurements.

14. The detection system of claim 13, wherein first material sample and the second material sample include different thicknesses.

15. The detection system of claim 14, wherein the first change to the component is formation of a surface layer and the second change to the component is diffusion of the surface layer to a selected depth.

16. The detection system of claim 14, wherein the first change to the component is diffusion of a surface layer to a first selected depth and the second change to the component is diffusion of the surface layer to a second selected depth.

17. The detection system of claim 14, wherein the changes to the first and second material samples are changes in electrical resistance, and wherein the first material sample and the second material sample are connected to the controller in series such that the controller is configured to measure a combined electrical resistance of the first material sample and the second material sample.

18. The detection system of claim 17, wherein the controller is configured to determine the first change to the component based on a first step change in the combined electrical resistance and determine the second change to the component based on a second step change in the combined electrical resistance.

19. The detection system of claim 13, wherein the change of the first material sample is caused by saturation of the first material sample by a surface layer formed through exposure to the process.

20. The detection system of claim 13, wherein the process is one of nitriding, carburizing, or boronizing.
